(19) United States
(12) Patent Application Publication
(10) Pub. No.: US 2025/0223984 A1
(43) Pub. Date: Jul. 10, 2025

(54) Fastener for a Round Hole and a Slot

(71) Applicant: Illinois Tool Works Inc., Glenview, IL (US)

(72) Inventor: Scott M. Liebelt, Eau Claire, WI (US)

(21) Appl. No.: 19/009,497

(22) Filed: Jan. 3, 2025

Related U.S. Application Data
(60) Provisional application No. 63/618,621, filed on Jan. 8, 2024.

(51) Int. Cl. F16B 5/06; F16B 21/08

(52) U.S. Cl. CPC F16B 5/065; F16B 21/086

(57) ABSTRACT

Disclosed is a fastener to connect a first component to a second component with an opening, whether round or a slot. The fastener includes a head portion that attaches to the first component and a retention portion, which is integrally connected to the head portion and engages with the second component. The retention portion includes a central stem that runs along a center axis and at least one clip wing that is resiliently attached to the distal end of the stem. Each clip wing has a first leg and a second leg, which are joined at one end to the central stem and at the other end to each other through an intermediate knuckle clip that extends outward from the center axis. Together, the first leg, second leg, and intermediate knuckle clip define an aperture.

### CROSS-REFERENCE

The present application claims priority to U.S. Provisional Patent Application No. 63/618,621, filed Jan. 8, 2024, and entitled “Fastener for a Round Hole and a Slot,” which is hereby incorporated by reference in its entirety.

### BACKGROUND

Automotive components require fastening techniques that are not only simple to manufacture and assemble but also highly reliable and efficient. To secure a secondary panel to a primary panel, fasteners are commonly used.

In some instances, fasteners engage with openings formed in one or both panels. These openings may vary in shape or form, such as slots or holes. However, existing fasteners are often specifically designed or optimized to work with only one type of opening, such as a round hole or a slot.

Despite advancements in fastening technology, there remains a need for a fastener that can effectively couple with both a slot-shaped openings and a round hole-shaped openings, providing greater versatility and functionality.

### SUMMARY

The present disclosure relates generally to a fastening system and fastener to form a connection between components, such as automotive panels, substantially as illustrated by and described in connection with at least one of the figures, as set forth more completely in the claims. More specifically, the present disclosure provides, in one example, a fastener that can effectively couple with both a slot and a round hole, providing greater versatility and functionality.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a and 1b illustrate, respectively, disassembled and assembled side views of an example fastening system configured to form a connection between components in accordance with aspects of this disclosure.

FIG. 2a illustrates an underside isometric view of the fastener in accordance with an aspect of this disclosure

FIG. 2b illustrates a topside isometric view of the fastener in accordance with an aspect of this disclosure

FIG. 2c illustrates a first elevational side view of the fastener.

FIG. 2d illustrates a first cross-sectional elevational side view of the fastener taken along cutline B-B (FIG. 2g).

FIG. 2e illustrates a second elevational side view of the fastener.

FIG. 2f illustrates a second cross-sectional elevational side view of the fastener taken along cutline C-C (FIG. 2g).

FIG. 2g illustrates a top plan view of the fastener of FIG. 2a.

FIG. 2h illustrates a bottom plan view of the fastener of FIG. 2a.

FIG. 2i illustrates a top plan view of the fastener taken along cutline A-A (FIG. 2c).

FIG. 2j illustrates a topside isometric view of the fastener taken along cutline A-A (FIG. 2c).

FIG. 2k illustrates a top plan view of the fastener taken along cutline D-D (FIG. 2c).

FIG. 2l illustrates a topside isometric view of the fastener taken along cutline D-D (FIG. 2c).

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A fastener can be used to form a connection between a first component and a second component, such as automotive panels. The disclosed fastener provides a seamless, integrally molded design that offers several advantages, including secure and repeatable engagement enabled by flexible retention features, adaptability to various opening shapes such as slots and round holes, and enhanced structural integrity provided by reinforced braces and a central stem. Additionally, its beveled lead-in nose and flexible retaining legs facilitate ease of installation.

In one example, a fastener for forming a connection between a first component and a second component having an opening comprises: a head portion configured to engage the first component; and a retention portion integrally formed with the head portion and configured to engage the second component, the retention portion including: a central stem defining a center axis; and at least one clip wing resiliently coupled to the central stem at a distal end of the central stem, wherein the at least one clip wing comprises: a first leg and a second leg, each coupled at a first end to the central stem and at a second end to one another, and an intermediate knuckle clip positioned between the first leg and a second leg and configured to flex toward the center axis during assembly.

In some examples, the first leg comprises a first knuckle and the second leg comprises a second knuckle. In some examples, the intermediate knuckle clip is connected to and extends between the first knuckle and the second knuckle. In some examples, the head portion includes a first plate and a second plate connected by a neck to define a gap between the first plate and the second plate. In some examples, the fastener is configured to secure the first component within the gap between the first plate and the second plate. In some examples, the fastener further comprises a collar integrally formed between the head portion and the retention portion. In some examples, the retention portion is configured to couple with the opening of the second component, regardless of whether the opening is shaped as a round hole or a slot. In some examples, each of the first leg and the second leg includes an intermediate beam extending from the distal end of the central stem to the first knuckle or the second knuckle, respectively. In some examples, each of the first leg and the second leg further includes a back-angle section extending inwardly toward the center axis. In some examples, the fastener further comprises a brace extending between the at least one clip wing and the central stem.

In another example, a fastener for forming a connection between a first component and a second component having an opening comprises: a central stem defining a center axis; and two clip wings resiliently coupled to the central stem at a distal end of the central stem, wherein each of the two clip wings comprises: a pair of legs coupled at a first end to the central stem and at a second end to one another, and an intermediate knuckle clip positioned between the pair of legs and configured to flex toward the center axis during assembly.

In some examples, each of the pair of legs comprises a knuckle. In some examples, the intermediate knuckle clip is positioned between the knuckle of each of the pair of legs. In some examples, the outer surface of the intermediate knuckle clip is contoured to bridge the pair of legs at the knuckle. In some examples, each of the two clip wings comprises a bridge portion between the pair of legs. In some examples, the intermediate knuckle clip is coupled to the bridge portion via a flexible stem. In some examples, the intermediate knuckle clip is positioned between the knuckle of each of the pair of legs.

In yet another example, a fastener for forming a connection between a first component and a second component having an opening comprises: a central stem defining a center axis; and two clip wings resiliently coupled to the central stem at a distal end of the central stem, wherein each of the two clip wings comprises: a pair of legs coupled at a first end to the central stem and at a second end to one another via a bridge portion, and an intermediate knuckle clip connected to the bridge portion via a flexible stem and positioned between the pair of legs, wherein the intermediate knuckle clip is configured to flex toward the center axis during assembly.

In some examples, the intermediate knuckle clip is positioned between the knuckle of each of the pair of legs. In some examples, the outer surface of the intermediate knuckle clip is contoured to bridge the pair of legs at the knuckle.

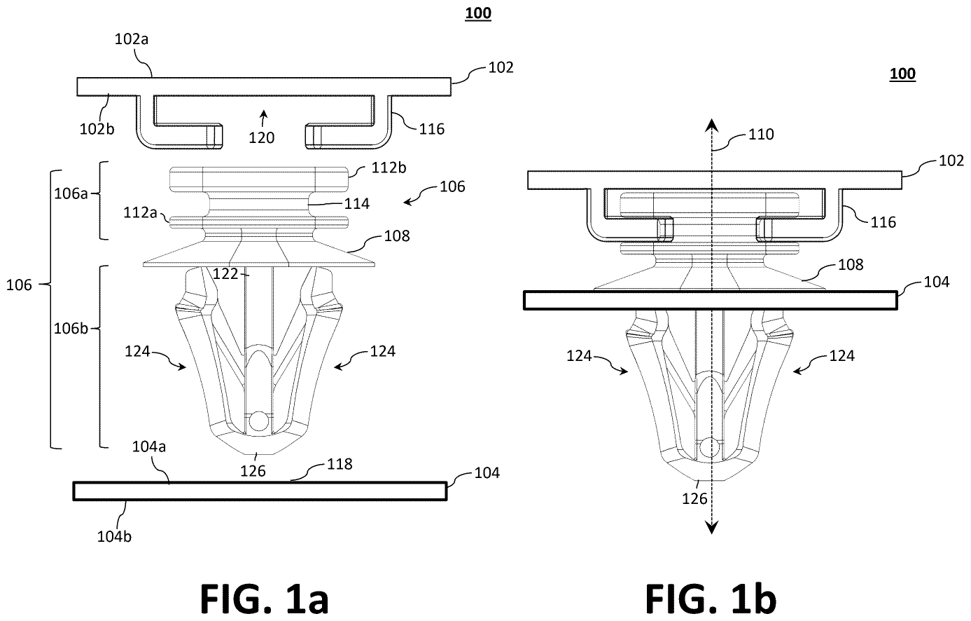

FIGS. 1a and 1b illustrate side views of an example fastening system 100 with a fastener 106 configured to form a connection between a first component 102 and a second component 104. The first component 102 and the second component 104 may be, for example, automotive panels. Depending on the application, the first component 102 and the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 102 include, without limitation, door trim panels, moldings, trim pieces, and other substrates (whether used as interior or exterior surfaces).

The first component 102 may define an A-surface 102a and a B-surface 102b (illustrated as an undersurface). The A-surface 102a, also called a class A surface, is typically the surface that is visible after assembly and, for that reason, is more aesthetically pleasing (e.g., textured, coated, or otherwise decorated) and typically free of attachment devices and/or related features. Conversely, the B-surface 102b, also called a class B surface, is typically the surface that is not visible after assembly and typically includes various attachment devices and/or related features. In the illustrated example, the first component 102 defines a doghouse feature 116, while the second component 104 defines an opening 118.

The second component 104 may be, for example, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. The second component 104 may define an A-surface 104a and a B-surface 104b (illustrated as an undersurface). Upon assembly, as best illustrated in FIG. 1b, the second component 104 is covered at least partially by the first component 102.

As illustrated, the fastener 106 is attached to the B-surface 102b and, depending on the material type, may be attached to the B-surface 102b after fabrication of the first component 102 (e.g., using adhesive or a mechanical attachment method, such as the illustrated doghouse feature 116). While only a single fastener 106 is illustrated in the examples, it should be appreciated that multiple fasteners 106 may be used to couple a first component 102 to a second component 104, depending on the number of fastener points needed between the first component 102 and second component 104. For example, larger panels typically require multiple fastener points.

The fastener 106 is a generally rigid component that generally defines a head portion 106a and a retention portion 106b extending along a center axis 110. In some examples, a collar 108 is positioned between the head portion 106a and the retention portion 106b. The head portion 106a can be formed integrally with the retention portion 106b and, where applicable, the collar 108.

The head portion 106a is configured to engage or otherwise attach to the first component 102. In the illustrated example, the head portion 106a generally defines a set of spaced-apart planar components (illustrated as first plate 112a and a second plate 112b) separated by a neck 114. In the illustrated embodiment, each of the first plate 112a and the second plate 112b is generally rectangular; however, one or both of the first plate 112a and the second plate 112b may alternatively be configured in other geometries, such as circular, oval, etc., depending on the desired application and/or shape of the doghouse feature 116. The dimensions and thickness of the disks may be adjusted to accommodate varying load requirements or space constraints.

The illustrated head portion 106a therefore comprises the first plate 112a and the second plate 112b, connected by the neck 114 to define a gap between the first plate 112a and the second plate 112b. The neck 114 extends between and integrally connects the first plate 112a to the second plate 112b. The illustrated neck 114 is cylindrical and ensures spacing between the first plate 112a to the second plate 112b to accommodate features of the first component 102, such as the doghouse feature 116. The neck 114 is aligned along the center axis 110, which also serves as the central axis for the overall fastener 106.

During assembly, a portion of the head portion 106a can be slid or slipped into a cavity 120 defined by the doghouse feature 116 of the first component 102. For example, the first plate 112a and the second plate 112b are sized and shaped such that the second plate 112b fits in the cavity 120. The cylindrical geometry of the neck 114 also allows for a degree of rotational alignment during installation. While illustrated as configured for use with the doghouse feature 116, the doghouse feature 116, the second plate 112b, and/or the neck 114 could be omitted and the fastener 106, or portion thereof, can be attached to or integrated with the first component via another means. For example, the head portion 106a can be adhesively secured to the first component 102. In another example, the first component 102 and the fastener 106 may be formed as a unitary structure. Therefore, while the present disclosure will be generally described in connection with a doghouse feature 116, the teachings of the present disclosure, such as those directed to the retention portion 106b may be applied to other types of fasteners where compatibility with both a round hole opening 118 and slot opening 118 is desired.

The retention portion 106b is configured to engage or otherwise attach to the second component 104. The retention portion 106b is configured to attach to the second component 104, embed in the second component 104, or pass through at least a portion of the second component 104 (e.g., via the opening 118). The opening 118 formed in the second component 104 defines a size and shape that is complementary to that of the retention portion 106b such that the retention portion 106b can be inserted and retained therein. In an example, the opening 118 can be generally circular (e.g., a round hole) and/or a slot (e.g., a narrow, rectangular opening).

The illustrated retention portion 106b comprises a central stem 122 and a pair clip wings 124 that is resiliently coupled to the central stem 122 at or adjacent, for example, a distal end of the central stem 122 (e.g., at or adjacent a lead-in nose 126). While a pair clip wings 124 are illustrated (i.e., two clip wings 124), additional or fewer clip wings 124 can be employed to meet design requirements for a given opening 118 size or shape.

The central stem 122 extends downward from the lower surface of the first plate 112a or, where applicable, the collar 108 along the center axis 110 to connect with a lead-in nose 126 via a shaft portion 128. The lead-in nose 126 can be beveled to facilitate the insertion of a distal end of the retention portion 106b of the fastener 106 into an opening 118 of the second component 104. The central stem 122 provides structural bracing to mitigate deformation of the retention portion 106b during installation and maintains alignment with the center axis 110. The lead-in nose 126 serves as a guide for the fastener during engagement, while the shaft portion 128 helps to ensure secure attachment between the stem 122 and the lead-in nose 126.

When assembled, the collar 108 is positioned between the first component 102 and second component 104 as illustrated in FIG. 1b. In some examples, the fastener 106 may include a seal to mitigate dust, dirt, and/or moisture penetration through the opening 118. The seal may be embodied as a ring (e.g., an annular structure) and fabricated from foam material, thermoplastic, rubber, etc. For example, the seal can be over molded onto the collar 108 or a seal can be configured to fit over the distal end of the fastener 106 to surround a portion of the fastener 106 (e.g., adjacent the collar 108) between the first component 102 and the second component 104. In some examples, the fastener 106 may include additional features, such as ribs and wings to mitigate noise and/or rattle between the first and second components 102, 104.

While it is contemplated that the fastener 106 would be manufactured as an integral component via a plastic injection molding process, other materials and/or processes are contemplated, such as additive manufacturing techniques. Using additive manufacturing techniques, components can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the fastener 106 may be fabricated with the first component 102 using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the first component 102 and the fastener 106 may be formed or otherwise fabricated at different resolutions during a printing operation. For example, the fastener 106 portion may be printed at a higher resolution than that of the first component 102 or vice versa as needed for a particular application.

In some examples, the first component 102 and the fastener 106 may be an integral printed thermoplastic material component. While it is contemplated that the first component 102 and the fastener 106 could be formed during the same printing session (i.e., printed during the same printing operation), it is possible that the fastener 106 may be printed onto a preexisting first component 102. For example, the first component 102 may be printed with one or more landmark structures (e.g., a protrusion or a recess) during a first session that can be located and filled and/or surrounded with material during a second session to form the fastener 106.

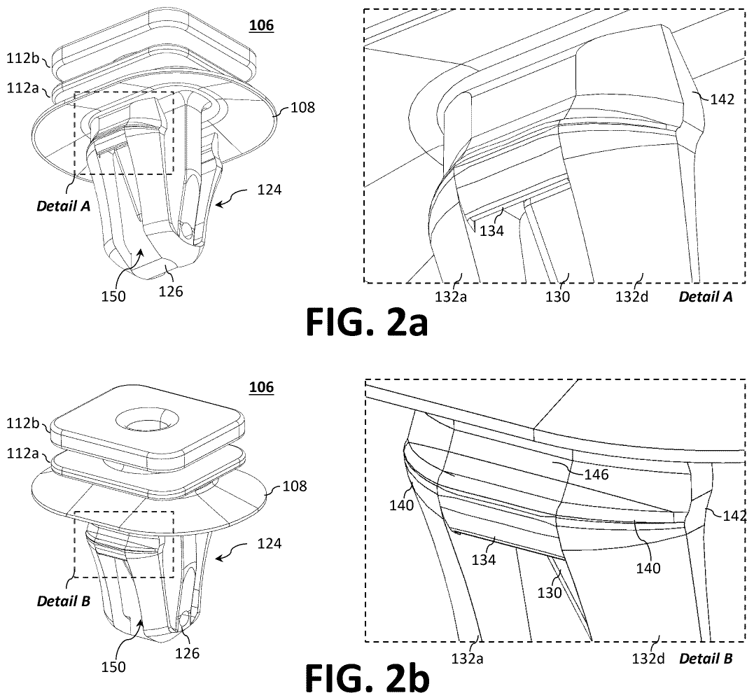

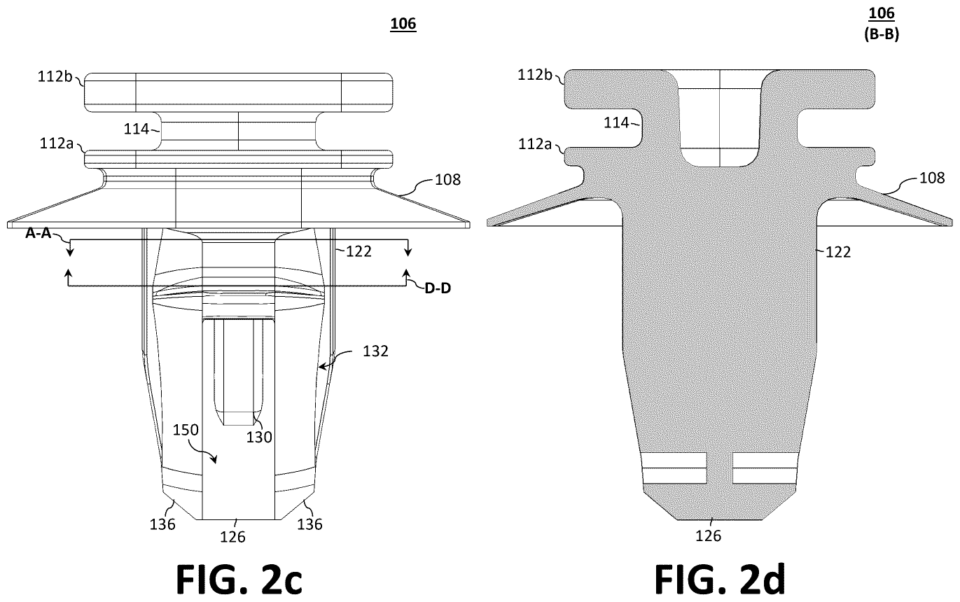

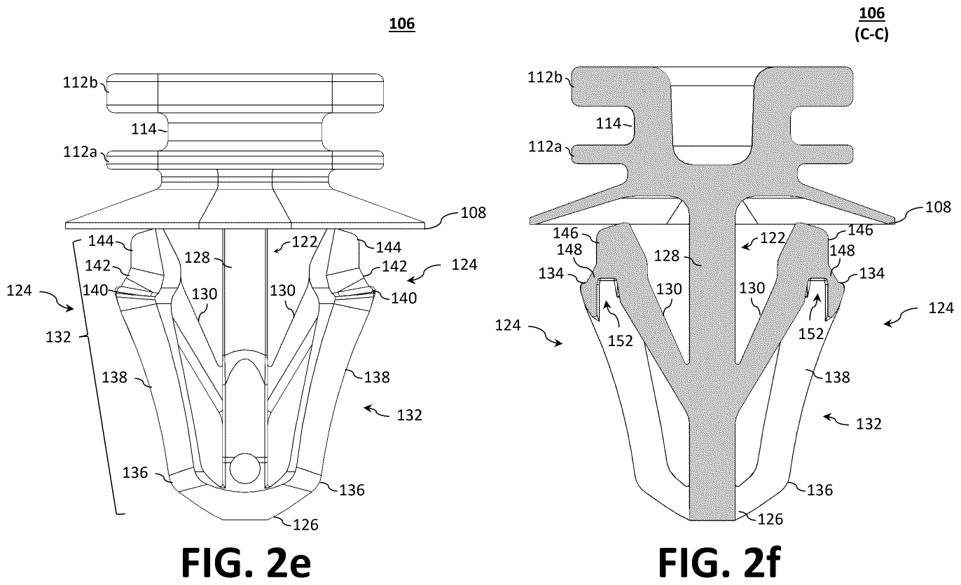

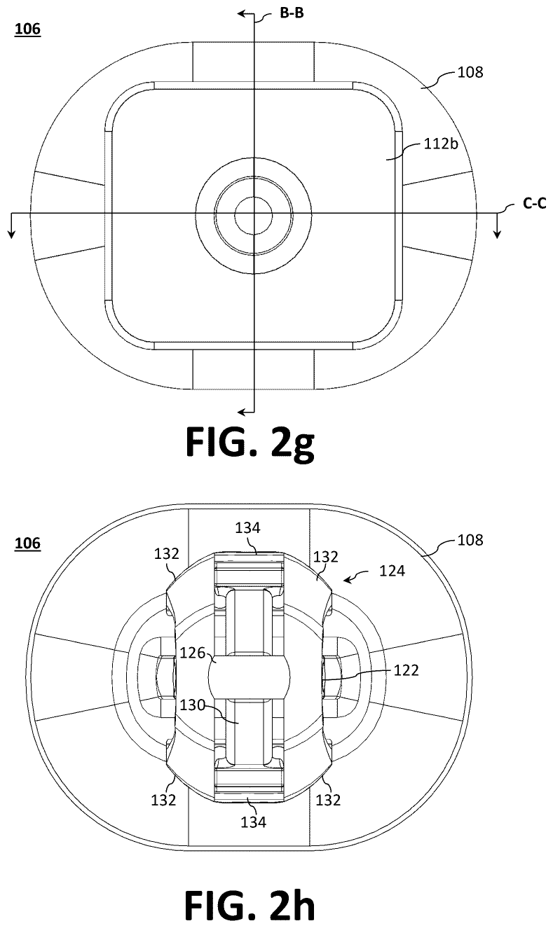

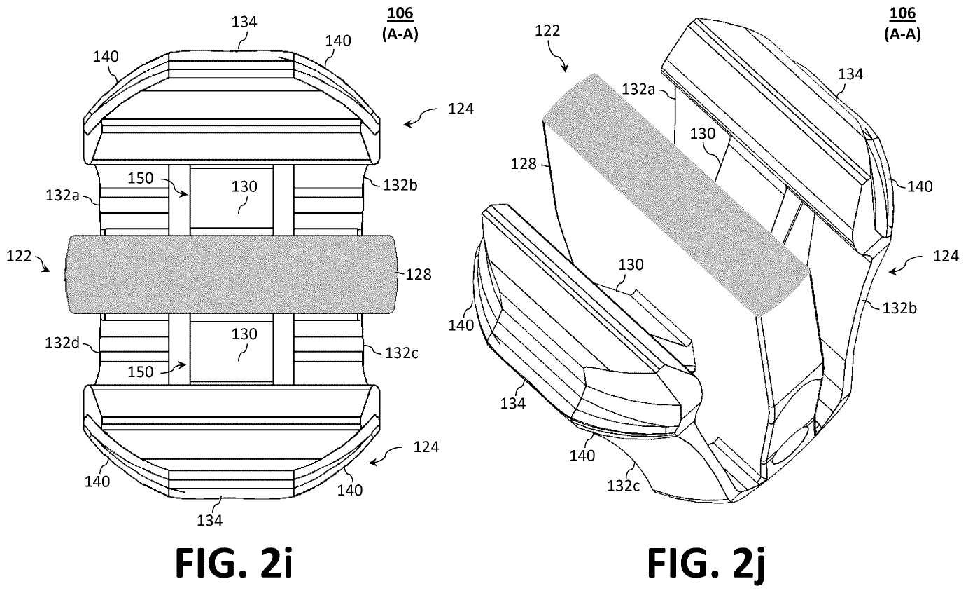

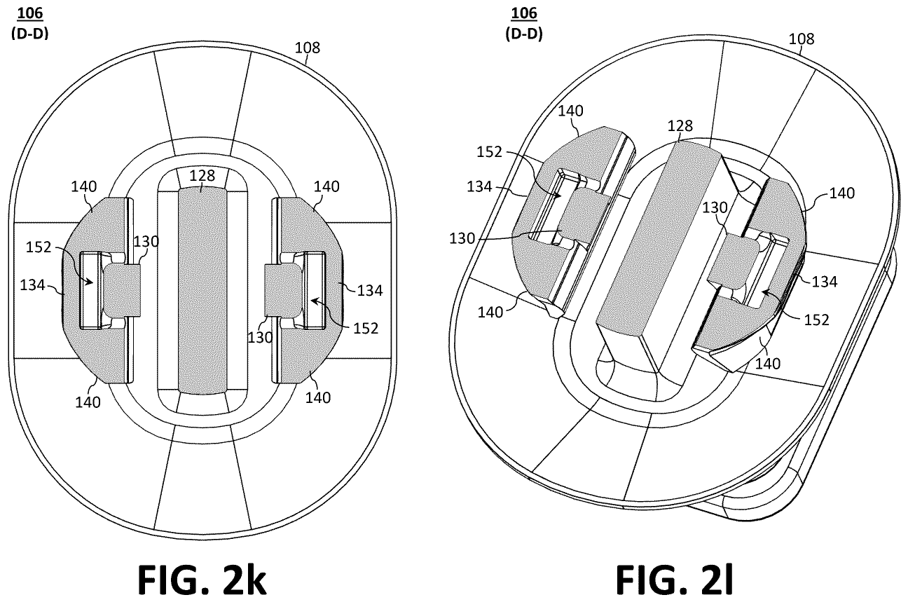

FIGS. 2a and 2b illustrate, respectively, underside and topside isometric views of the fastener 106 in accordance with an aspect of this disclosure FIG. 2c illustrates a first elevational side view of the fastener 106, while FIG. 2d illustrates a first cross-sectional elevational side view of the fastener 106 taken along cutline B-B (FIG. 2g). FIG. 2e illustrates a second elevational side view of the fastener 106, while FIG. 2f illustrates a second cross-sectional elevational side view of the fastener 106 taken along cutline C-C (FIG. 2g). FIGS. 2g and 2h illustrate, respectively, top and bottom plan views of the fastener 106 of FIG. 2a. FIG. 2i illustrates a top plan view of the fastener 106 taken along cutline A-A (FIG. 2c), while FIG. 2j illustrates a topside isometric view thereof. Finally, FIG. 2k illustrates a top plan view of the fastener taken along cutline D-D (FIG. 2c), while FIG. 2l illustrates a topside isometric view thereof.

As mentioned previously, the retention portion 106b comprises a central stem 122 and a pair clip wings 124 that is resiliently coupled to the central stem 122 at or adjacent, for example, the lead-in nose 126. Each of the illustrated pair clip wings 124 includes one or more braces 130, an intermediate knuckle clip 134, and a plurality of retaining legs 132 that extend outward and upward from the lead-in nose 126 and the central stem 122.

In the illustrated example, the retention portion 106b employs a pair of clip wings 124, including a first clip wing 124 and a second clip wing 124. Each of the clip wing 124 can generally comprise a pair of spaced-apart retaining legs 132 the define, together with the lead-in nose 126 and bridge portion 146, an aperture 150. The first clip wing 124 includes a first retaining leg 132a and a second retaining leg 132b, while the second clip wing 124 includes a third retaining leg 132c and a fourth retaining leg 132d. The retaining legs 132 can be symmetrically arranged about the center axis 110 to provide a uniform load distribution and engagement.

With referent to FIG. 2e, each retaining leg 132 can be composed of multiple sections, including, for example, a flexible root 136, an intermediate extension beam 138, a knuckle 140, a back-angled section 142, and a tab 144. The flexible root 136 is located at a base end of each retaining leg 132 and is coupled to or at the lead-in nose 126. The flexible root 136 allows the retaining leg 132 to bend or flex inward toward the center axis 110 the during installation, facilitating smooth passage of the retention portion 106b through the opening 118 of the second component 104.

The intermediate extension beam 138 extends from the flexible root 136. In some examples, as illustrated in FIGS. 2e and 2f, the intermediate extension beam 138 features a concave outer surface and increases in outward extension toward the knuckle 140. This geometry enhances the leg's ability to spring back into place after passing through the opening 118.

The knuckle 140 is positioned at the transition between the intermediate extension beams 138 and the back-angled sections 142. The knuckle 140 serves as a retention feature configured to secure the fastener 106 in place after installation. In some embodiments, the knuckles 140 may be reconfigured based on specific design requirements.

The back-angled section 142 is coupled to and extends from the knuckle 140. Angling the back-angled section 142 inward toward the central stem 122 provides additional retention strength and prevents inadvertent dislodgment of the fastener 106.

The tab 144 extends upward from the back-angled sections 142 toward the lower surface of the first plate 112a (or collar 108, as applicable). The tab 144 can create a gap that allows for slight flexing during engagement, improving the adaptability of the fastener 106.

One or more braces 130 are positioned between the central stem 122 and each pair of adjacent retaining legs 132. In this example, the pairs are illustrated as the first retaining leg 132a and second retaining leg 132b defining one set and the third retaining leg 132c and fourth retaining leg 132d defining another set. As best illustrated in FIG. 2f, the braces 130 are coupled to and extend from the central stem 122 to attach to the interior surfaces of adjacent legs 132 at an angle, thereby forming, or attaching to, a bridge portion 146 between adjacent legs 132 that provides additional structural reinforcement to the clip wing 124.

The braces 130 are configured to distribute loads between the central stem 122 and each pair of retaining legs 132, preventing deformation and improving the overall durability of the fastener. In some examples, the braces 130 can be omitted and a bridge portion 146 can be formed between the interior surfaces of adjacent legs 132 (e.g., between adjacent back-angled sections 142 and/or and tabs 144) to provide structural reinforcement and to provide an attachment point for other features, such as an intermediate knuckle clip 134 (e.g., between adjacent knuckles 140).

The intermediate knuckle clip 134, as best illustrated in FIGS. 2a (Detail A), 2b (Detail B), 2f (cross-sectional), and 2l (cross-sectional), is positioned between each pair of retaining legs 132. In this example, the intermediate knuckle clip 134 is positioned between adjacent knuckles 140 of each clip wing 124. The intermediate knuckle clip 134 serves as a retention feature configured to secure the fastener 106 in place via the opening 118 after installation, particularly in instances where the opening 118 is a slot shape.

In the illustrated example, the intermediate knuckle clip 134 is positioned between the knuckles 140 of each pair of retaining legs 132. As best illustrated in FIG. 2e, the intermediate knuckle clip 134 is resiliently coupled to the bridge portion 146 via a flexible stem 148. The intermediate knuckle clip 134 is spaced from the braces 130 by a gap 152. During installation, the intermediate knuckle clip 134 is configured to flex inward toward the brace 130, narrowing the gap 152 during compression.

As illustrated, the exterior surface of the intermediate knuckle clip 134 is contoured to continue bridge the gap between the two adjacent knuckles 140. The intermediate knuckle clip 134 additional material between the knuckles 140 improves contact area and function in an opening 118 that is shaped as a slot. Notably, the additional material of the intermediate knuckle clip 134 provides limited interference with openings 118 that are shaped as round holes, thus allowing the fastener 106 to be installed in openings 118 that are shaped as a slot and openings 118 that are shaped as a round hole. This cross-compatibility allows the user to use a single fastener regardless of opening shape;

During assembly, the fastener 106 is attached to the first component 102 by sliding the head portion 106a into a cavity 120 defined by a doghouse feature 116. This attachment ensures that the fastener remains securely in place during alignment with the second component 104.

The first component 102, with the attached fastener 106, is aligned relative to the second component 104 such that the lead-in nose 126 aligns with an opening 118 in the second component. The opening 118 may be a slot, a round hole, or any other compatible shape.

Upon application of force, the retaining legs 132 (e.g., the first retaining leg 132a, a second retaining leg 132b, a third retaining leg 132c, and a fourth retaining leg 132d) flex inward toward the center axis 110 as the retention portion 106b is urged through the opening 118. Once the knuckles 140 and intermediate knuckle clip 134 pass beyond the opening edges, the retaining legs snap outward, securing the fastener 106 in place. The first component 102 is then firmly retained between the first plate 112a and the second plate 112b.

The inclusion of intermediate knuckle clips 134 and flexible retaining legs 132 allows the fastener 106 to engage openings of varying shapes and sizes, which promotes compatibility across a broad range of applications, including but not limited to automotive, aerospace, and consumer product assemblies.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A fastener for forming a connection between a first component and a second component having an opening, the fastener comprising:
a head portion configured to engage the first component; and
a retention portion integrally formed with the head portion and configured to engage the second component, the retention portion including:
a central stem defining a center axis; and
at least one clip wing resiliently coupled to the central stem at a distal end of the central stem,
wherein the at least one clip wing comprises:
a first leg and a second leg, each coupled at a first end to the central stem and at a second end to one another, and
an intermediate knuckle clip positioned between the first leg and a second leg and configured to flex toward the center axis during assembly.

2. The fastener of claim 1, wherein the first leg comprises a first knuckle and the second leg comprises a second knuckle.

3. The fastener of claim 2, wherein the intermediate knuckle clip is connected to and extends between the first knuckle and the second knuckle.

4. The fastener of claim 1, wherein the head portion includes a first plate and a second plate connected by a neck to define a gap between the first plate and the second plate.

5. The fastener of claim 4, wherein the fastener is configured to secure the first component within the gap between the first plate and the second plate.

6. The fastener of claim 1, further comprising a collar integrally formed between the head portion and the retention portion.

7. The fastener of claim 4, wherein the retention portion is configured to couple with the opening of the second component, regardless of whether the opening is shaped as a round hole or a slot.

8. The fastener of claim 2, wherein each of the first leg and the second leg includes an intermediate beam extending from the distal end of the central stem to the first knuckle or the second knuckle, respectively.

9. The fastener of claim 8, wherein each of the first leg and the second leg further includes a back-angle section extending inwardly toward the center axis.

10. The fastener of claim 1, further comprising a brace extending between the at least one clip wing and the central stem.

11. A fastener for forming a connection between a first component and a second component having an opening, the fastener comprising:
a central stem defining a center axis; and
two clip wings resiliently coupled to the central stem at a distal end of the central stem, wherein each of the two clip wings comprises:
a pair of legs coupled at a first end to the central stem and at a second end to one another, and
an intermediate knuckle clip positioned between the pair of legs and configured to flex toward the center axis during assembly.

12. The fastener of claim 11, wherein each of the pair of legs comprises a knuckle.

13. The fastener of claim 12, wherein the intermediate knuckle clip is positioned between the knuckle of each of the pair of legs.

14. The fastener of claim 12, wherein an outer surface of the intermediate knuckle clip is contoured to bridge the pair of legs at the knuckle.

15. The fastener of claim 12, wherein each of the two clip wings comprises a bridge portion between the pair of legs.

16. The fastener of claim 15, wherein the intermediate knuckle clip is coupled to the bridge portion via a flexible stem.

17. The fastener of claim 12, wherein the intermediate knuckle clip is positioned between the knuckle of each of the pair of legs.

18. A fastener for forming a connection between a first component and a second component having an opening, the fastener comprising:
a central stem defining a center axis; and
two clip wings resiliently coupled to the central stem at a distal end of the central stem, wherein each of the two clip wings comprises:
a pair of legs coupled at a first end to the central stem and at a second end to one another via a bridge portion, and
an intermediate knuckle clip connected to the bridge portion via a flexible stem and positioned between the pair of legs, wherein the intermediate knuckle clip is configured to flex toward the center axis during assembly.

19. The fastener of claim 18, wherein the intermediate knuckle clip is positioned between the knuckle of each of the pair of legs.

20. The fastener of claim 18, wherein an outer surface of the intermediate knuckle clip is contoured to bridge the pair of legs at the knuckle.
